(19) United States
(12) Patent Application Publication
(10) Pub. No.: US 2022/0327182 A1
(43) Pub. Date: Oct. 13, 2022

(54) UNSUPERVISED AND NONPARAMETRIC APPROACH FOR VISUALIZING OUTLIERS BY INVARIANT DETECTION SCORING

(71) Applicants: Waleed Ahmed Yousef, Victoria (CA); Issa Traoré, Victoria (CA); William Ryan Briguglio, Victoria (CA)

(72) Inventors: Waleed Ahmed Yousef, Victoria (CA); Issa Traoré, Victoria (CA); William Ryan Briguglio, Victoria (CA)

(21) Appl. No.: 17/710,635

(22) Filed: Mar. 31, 2022

Related U.S. Application Data
(60) Provisional application No. 63/168,686, filed on Mar. 31, 2021.

(51) Int. Cl. G06F 17/18; G06F 17/16

(52) U.S. Cl. CPC G06F 17/18; G06F 17/16

(57) ABSTRACT

A method implements an unsupervised and nonparametric approach for visualizing outliers by invariant detection scoring. The method includes receiving a selection of input data comprising a plurality of input values. The method further includes processing the input data to generate a distance matrix. The method further includes processing the distance matrix to generate neighborhood cumulative distribution function (NCDF) curves. The method further includes processing the NCDF curves to generate scores. The method further includes processing the scores to identify an anomalous value, in the input data, that corresponds to a score, of the scores, meeting a criterion.

### CROSS-REFERENCE TO RELATED APPLICATIONS

This application claims priority to U.S. Provisional Application No. 63/168,686, filed Mar. 31, 2021, which is herein incorporated by reference.

### BACKGROUND

An outlier in data is an unusual occurrence in the data that is also referred to as an anomaly. Outlier detection is used in different fields and disciplines, including disease diagnosis in medicine, intrusion and malware detection in cybersecurity, fault detection in quality assurance, and so on.

Despite the progress made in using statistical and artificial intelligence techniques for outlier detection, automated outlier detection faces significant challenges which limit its effectiveness. A challenge is the difficulty in defining and collecting meaningful outlier samples, which represent ground-truth information as well as visualization of the information.

### SUMMARY

In general, in one or more aspects, the disclosure relates to a method that implements an unsupervised and nonparametric approach for visualizing outliers by invariant detection scoring. The method includes receiving a selection of input data comprising a plurality of input values. The method further includes processing the input data to generate a distance matrix. The method further includes processing the distance matrix to generate neighborhood cumulative distribution function (NCDF) curves. The method further includes processing the NCDF curves to generate scores. The method further includes processing the scores to identify an anomalous value, in the input data, that corresponds to a score, of the scores, meeting a criterion.

In general, in one or more aspects, the disclosure relates to a system. The system includes a scoring controller configured to generate scores. The system further includes an application executing on one or more computers. The application is configured for receiving a selection of input data comprising a plurality of input values. The application is further configured for processing the input data to generate a distance matrix. The application is further configured for processing the distance matrix to generate neighborhood cumulative distribution function (NCDF) curves. The application is further configured for processing the NCDF curves to generate scores. The application is further configured for processing the scores to identify an anomalous value, in the input data, that corresponds to a score, of the scores, meeting a criterion.

A method uses an unsupervised and nonparametric approach for visualizing outliers by invariant detection scoring. The method includes transmitting a request. The method further includes displaying a neighborhood cumulative distribution function (NCDF) graph in response to the request. The method further includes receiving a selection of input data comprising a plurality of input values. The method further includes processing the input data to generate a distance matrix. The method further includes processing the distance matrix to generate neighborhood cumulative distribution function (NCDF) curves. The method further includes processing the NCDF curves to generate scores. The method further includes processing the scores to identify an anomalous value, in the input data, that corresponds to a score, of the scores, meeting a criterion. The method further includes selecting an NCDF curve, of the NCDF curves, that corresponds to the anomalous value. The method further includes highlighting the NCDF curve.

Other aspects of the invention will be apparent from the following description and the appended claims.

### BRIEF DESCRIPTION OF DRAWINGS

FIG. 1 show diagrams of systems in accordance with disclosed embodiments.

FIG. 2 shows a flowchart in accordance with disclosed embodiments.

FIG. 3 shows examples in accordance with disclosed embodiments.

FIG. 4.1 and FIG. 4.2 show computing systems in accordance with disclosed embodiments.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure implement an unsupervised and nonparametric approach for visualizing outliers by invariant detection scoring. For example, a user accesses a system, e.g., a software application, to analyze a set of data and find outliers within the data. The application may be a web application, a locally executing application, or any other type of software application. The user selects the data to analyze and the system generates scores for the data using an neighborhood cumulative distribution function (NCDF). The scores are generated for each input of the data and identify the “outlierness” of the of the input values. The scores are proportional to the how much of an outlier an input value is with respect to the other input values. An input value that is more of an outlier than another input value will have a larger score.

The system provides a visualization using one or more graphs. A graph may be provided that includes NCDF curves, with an NCDF curve generated for each input value. The NCDF curves may be adjusted (e.g., highlighted) to visually identify and differentiate NCDF curves within the graph that correspond to input values that are outliers. Multiple methods for outlier identification may be used, including a fraction of gap method and a histogram method. In addition to the graph of the NCDF curves additional graphs and plots may be generated and displayed. For example, a scatter plot matrix and parallel coordinate plots may be provided. The graph of the NCDF curves shows which input values are outliers and the additional graphs and plots show portions of the underlying data that make an input value an outlier.

The figures of the application show diagrams of embodiments that are in accordance with the disclosure. The embodiments of the figures may be combined and may include or be included within the features and embodiments described in the other figures of the application. The features and elements of the figures are, individually and as a combination, improvements to the technology of outlier detection systems. The various elements, systems, components, and steps shown in the figures may be omitted, repeated, combined, and/or altered as shown from the figures. Accordingly, the scope of the present disclosure should not be considered limited to the specific arrangements shown in the figures.

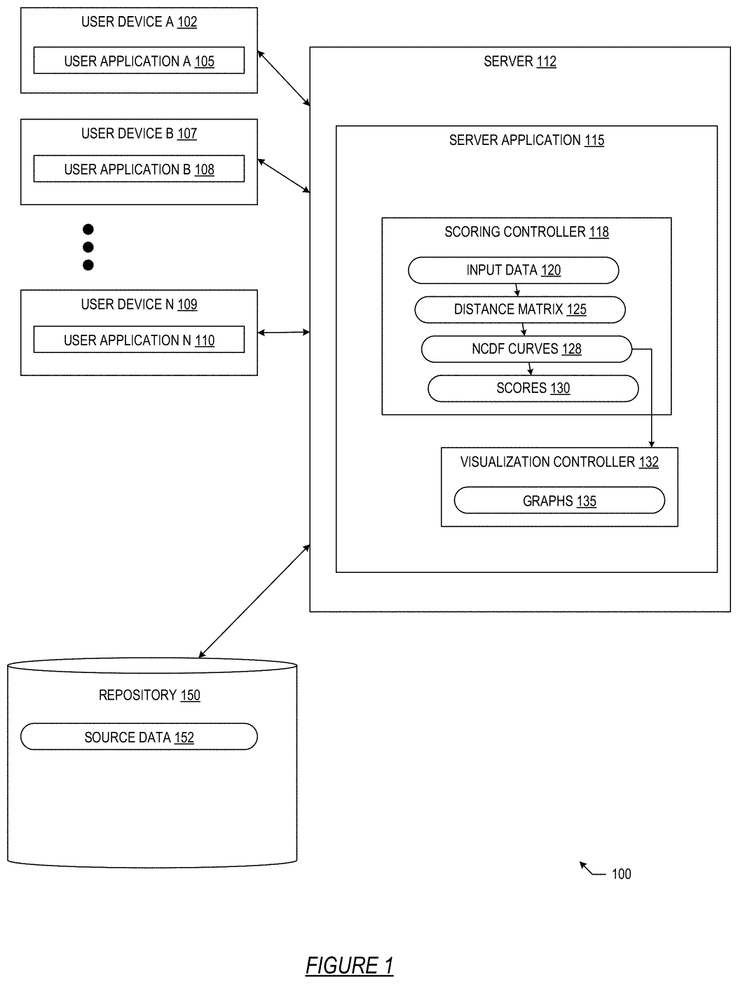

Turning to FIG. 1, the system (100) implements an unsupervised and nonparametric approach for visualizing outliers by invariant detection scoring. Although shown using distributed computing architectures and systems, other architectures and systems may be used. In one embodiment, the server application (115) and the user applications A (105) and B (108) through N (110) may be part of a monolithic applications that implement unsupervised and nonparametric approach for visualizing outliers by invariant detection scoring.

Visualizations of input values that are outliers within the source data (152) are provided with the graphs (135) and the scores (130). Users operate the user devices A (102) and B (107) through N (109) to access the server application (115). Users identify data from source data (152) that is analyzed by the server application (115), which may use neighborhood cumulative distribution functions (NCDFs). The system (100) includes the user devices A (102) and B (107) through N (109), the server (112), and the repository (150).

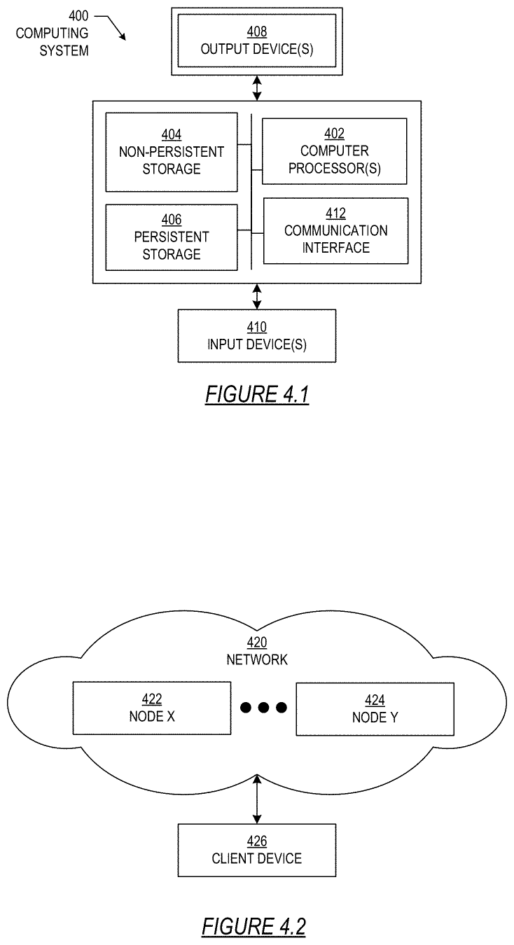

The server (112) is a computing system (further described in FIG. 4.1). The server (112) may include multiple physical and virtual computing systems that form part of a cloud computing environment. In one embodiment, execution of the programs and applications of the server (112) is distributed to multiple physical and virtual computing systems in the cloud computing environment. The server (112) includes the server application (115).

The server application (115) is a collection of programs that may execute on multiple servers of a cloud environment, including the server (112). The server application (115) processes the source data (152) using the scoring controller (118) and the visualization controller (132) to identify and present visualizations of outliers of input values of the source data (152). In one embodiment, the server application (115) may host services accessed by users of the user devices A (102) and B (107) through N (109). The services hosted by the server application (115) may serve structured documents (hypertext markup language (HTML) pages, extensible markup language (XML) pages, JavaScript object notation (JSON) files and messages, etc.). The server application (115) includes the scoring controller (118) and the visualization controller (132).

The scoring controller (118) is a collection of programs that may operate on the server (112). The scoring controller (118) processes the source data (152) to identify and generate the input data (120), the distance matrix (125), the NCDF curves on (128), and the scores (130).

The input data (120) is a subset of the source data (152). The input data (120) may be selected by a user with, e.g., the user device A (102). The input data includes multiple input values. Each input value may have a number of dimensions (5, 100, 10,000, etc.) with a numerical value for each dimension. An input value identifies a coordinate in a multidimensional real space. The input value x is identified symbolically as x∈ [symbol] ^{d}. As an example, the input data (120) may include 200,000 input values that each have 10 dimensions that are selected as a subset from data having millions of values, each with thousands of dimensions, from the source data (152). The input values of the input data (120) may be normalized to [0,1] along each dimension so that the dataset exists in a d-dimensional cube [0,1]^{d}.

The distance matrix (125) is an n×n matrix generated by processing the input data (120). Each row and each column of the distance matrix (125) correspond to an input value from the input data (120). The values of the distance matrix (125) are the distances between the input values identified by the rows and columns of the distance matrix (125). For example, a value of “3.14” at the fourth row and eighth column indicates that the distance between the fourth input value and the eighth input value is “3.14”. The distance function used may be any norm. In one embodiment, a norm is a function from a real or complex vector space to the non-negative real numbers, which may behave like a distance from the origin that commutes with scaling, obeys a form of the triangle inequality, and may be zero only at the origin. The distance matrix (125) values, between each pair of input values, may be built under any selected L^{p} norm. For example, an infinitesimal p=2⁻⁴ norm may be used. When p is infinity, i.e., L^{∞}, the distance is called Chebyshev distance. When p is 1, the distance is called city-block distance. When p is 2, the distance is called Euclidean distance. Other distances or norms can be used rather than the L^{p} norm. In one embodiment, the Chebyshev distance may be used where the distance between two input values is the greatest of the differences along any coordinate dimension of the input values. For example, between an input value of “3, 1, 8” and “5, 9, 11”, the distance may be “8” corresponding to distance between the second dimension values “1” and “9”, which is the longest distance of the three dimensions. In one embodiment, each row of the distance matrix (125) may be sorted in ascending order (smallest to largest).

The neighborhood cumulative distribution function (NCDF) curves (128). In one embodiment, an NCDF curve is generated for each input value of the input data (120). An NCDF curve may be drawn as follows. A neighborhood is defined having a center at L^{p} under the norm p, with a volume v. The number of observations existing within this neighborhood is counted to identify the number of elements in the sorted distance matrix (125) having values less than the selected volume v. The percentage of the number of observations versus the selected volume v represents a single point on the NCDF. An NCDF curve is a plot of the fraction of observations within a neighborhood, of a center xi, versus the volume of this neighborhood. Data of an NCDF curve may be stored in a data structure as coordinate pairs with a first axis (e.g., an x-axis) representing volume (from 0 to 1) and a second axis (e.g., a y-axis) representing the fraction of observations (from 0 to 1) existing within a neighborhood of volume v.

The scores (130) are metrics that identify whether an input value is an outlier. The scores (130) quantify the outlierness of the input values of the input data (120). The scores (130) may be normalized to the range [0,1]. Different methods may be used, including a fraction of gaps method and a histogram method. In one embodiment, the “fraction of gaps” method calculates the distances between an intercept of the NCDF curves with the other intercepts of the NCDF curves and assigns the [nr]^{th} smallest distance, where 0<r<1 is a relaxing parameter, as the score. In one embodiment, the “histogram” method creates b bins for the intercepts of the NCDF curves (128) with the i^{th} intercept being centered in one of the bins. Counts of the intercepts in each bin are calculated to identify the anomaly score. The score (the counts) are normalized to the range [0,1]. Different methods may be used to generate the scores (130), including density estimation and image processing methods that treat the NCDF space as an image.

The visualization controller (132) is a collection of programs that may operate on the server (112). The visualization controller (132) generates the graphs (135) that are presented to the user devices A (102) and B (107) through N (109).

The graphs (135) are visualizations of the data and analysis generated with the system (100). In one embodiment, the graphs (135) include NCDF graphs and additional graphs. The additional graphs may include a matrix of scatter plots (referred to as a scatter plot matrix), and a parallel coordinate plot.

An NCDF graph is a plot of the NCDF curves (128). Each of the NCDF curves (128) (which are normalized in both domain and range to [0,1]) for each of the input values of the input data may be included in the NCDF graph. An NCDF curve that corresponds to an input value that is identified as an outlier may be highlighted in the NCDF graph.

A scatter plot matrix is a grid (or matrix) of scatter plots that visualizes bivariate relationships between combinations of variables. Each scatter plot in the matrix visualizes the relationship between a pair of variables, to show many relationships in one chart.

A parallel coordinate plot displays each variable on an axis for that variable with each of the axes are arranged parallel. Each axis may have a different scale with each variable working on a different unit of measurement. In one embodiment, the axes may be normalized to present uniform scales. Input values from the input data (120) are plotted as a series of lines that connect across the axes. Each line is a collection of points placed on each axis. A parallel coordinate plot may be generated that includes an axis for each dimension of the input values of the input data (120). In one embodiment, multiple parallel coordinate plots may be generated with the different parallel coordinate plots having axes for different subsets of the dimensions of the input values of the input data (120).

The user devices A (102) and B (107) through N (109) are computing systems (further described in FIG. 4.1). For example, the user devices A (102) and B (107) through N (109) may be desktop computers, mobile devices, laptop computers, tablet computers, server computers, etc. The user devices A (102) and B (107) through N (109) include hardware components and software components that operate as part of the system (100). The user devices A (102) and B (107) through N (109) communicate with the server (112) to access and manipulate information, including the source data (152). The user devices A (102) and B (107) through N (109) may communicate with the server (112) using standard protocols and file types, which may include hypertext transfer protocol (HTTP), HTTP secure (HTTPS), transmission control protocol (TCP), internet protocol (IP), hypertext markup language (HTML), extensible markup language (XML), etc. The user devices A (102) and B (107) through N (109) respectively include the user applications A (105) and B (108) through N (110).

The user applications A (105) and B (108) through N (110) may each include multiple programs respectively running on the user devices A (102) and B (107) through N (109). The user applications A (105) and B (108) through N (110) may be native applications, web applications, embedded applications, etc., and may present and display information to users. In one embodiment, the user applications A (105) and B (108) through N (110) include web browser programs that display web pages from the server (112). In one embodiment, the user applications A (105) and B (108) through N (110) provide graphical user interfaces that display data processed by the system (100).

The user application A (105) may be used by a user to select the input data (120) from the source data (152). After selecting the input data (120), a system (100) analyzes the input data to generate the scores (130) and the graphs (135). The graphs (135) may be transmitted to and displayed by the user application A (105). In one embodiment, after generating the scores (130) and detecting an outlier, assistant may transmit a message, which may include a notification to the user application A (105) that the outlier was detected.

As an example, a user may login to the system (100) to explore the source data (152). The user selects the input data (120) from the source data (152) and the server application (115) generates and presents the graphs (135) to the user application A (105). The graphs (135) may include an NCDF graph of the NCDF curves (128) and additional graphs. The additional graphs may include a scatter plot matrix, a parallel coordinate plot, etc.

The repository (150) is a computing system that may include multiple computing devices in accordance with the computing system (400) and the nodes (422) and (424) described below in FIGS. 4.1 and 4.2. The repository (150) may be hosted by a cloud services provider that also hosts the server (112). The cloud services provider may provide hosting, virtualization, and data storage services, as well as other cloud services, and to operate and control the data, programs, and applications that store and retrieve data from the repository (150). The data in the repository (150) includes the source data (152). In one embodiment, the data in the repository (150) is stored as records with numerical values in one or multiple databases or files.

The source data (152) is data that is processed by the system (100) to generate the scores (130) and the graphs (135). Different domains of data may be analyzed by the system.

Network security is one domain to apply the anomaly detection provided by the system (100). Network activity that is considered as a network attack will have a feature vector that looks strange (“anomalous”) if compared to other network activities. These anomalies may be identified by the system (100) and show up in the scores (130) and the graphs (135). The multidimensional input values of network security data may be stored in columns of a table of a database. The table may include columns that identify different types of information about packets being transferred through the network, including time sent, payload size, source address, destination address, etc.

Disease detection is another domain to apply the anomaly detection provided by the system (100). For example, tissue data (including mass, microcalcification, bilateral asymmetry, etc., of the tissue) may show an abnormality (an “anomaly”) that may be identified as an outlier using the system (100).

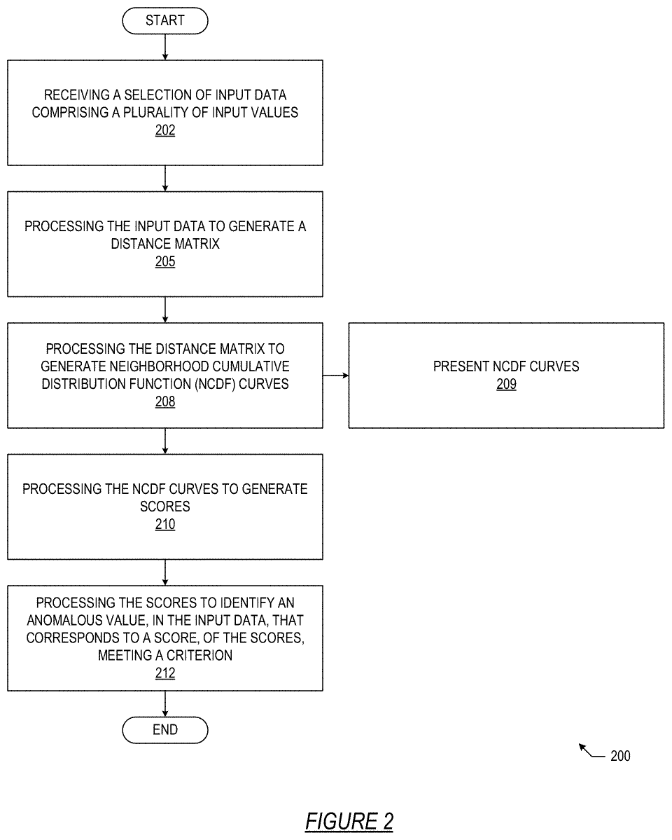

Turning to FIG. 2, the process (200) implements unsupervised and nonparametric outliers detection with invariant detection scoring. The process (200) may be performed using a client server architecture with multiple programs executing on multiple computing devices communicating through a network.

At Step 202, a selection of input data that includes a plurality of input values is received. The input values are elements of the same multidimensional real space ( [symbol] ^{d}). In one embodiment, the selection may include a query, in a query language (e.g., structured query language (SQL)), that identifies the input data from the records of one or multiple databases. The selection may be received from a user device in response to a user input.

At Step 205, the input data is processed to generate a distance matrix. In one embodiment, the distance matrix includes a number of rows corresponding to the plurality of input values and a number of columns corresponding to the plurality of input values and may be an n×n matrix. In one embodiment, the input data is normalized to values between and including “0” and “1”, i.e., to the range [0,1]. In one embodiment, the distance matrix is generated by calculating Chebyshev distances between each of the plurality of input values. The distance matrix between each pair of input values may be built under any selected LP norm. For example, an infinitesimal p=2⁻⁴ norm may be used. Other values ofp may be used and a norm other than the LP norm may be used.

At Step 208, the distance matrix is processed to generate neighborhood cumulative distribution function (NCDF) curves. The space of the NCDF curves are [symbol] 2, and is not a projection of the [symbol] ^{d} space of the input values onto the [symbol] ² space

of the NCDF curves. NCDF is a lossless transformation of the probability space. In one embodiment, the following definitions may be used to generate the NCDF curves using sample NCDFs. In one embodiment, the distance matrix is generated under the p-norm with an infinitesimal value of p.

Definition 1

The closed neighborhood (or ellipsoid) of radius ∈, under the general norm ∥⋅∥and a transformation matrix A, centered around x₀∈ [symbol] ^{d} is defined as:

$${𝒩}_{‖ \cdot ‖ , A} ( {x}_{0} , ϵ ) = \{ x \vert ‖ {A}^{- 1} ( x - {x}_{0} ) ‖ \leq ϵ \} . \qquad Eq . 1$$

A special norm of interest is the LP-norm, L^{p}-norm, ∥x∥ₚ=(Σᵢ|xᵢ|^{p})^{1/p}. The orientation and axes' length of the general ellipsoid in [symbol] ^{d} are determined by the eigenvectors vᵢs and the eigenvalues λᵢs of A, respectively.

For p<1, [symbol] is non-convex. Regardless of the dimensionality d and data transformation A, the neighborhood with p<1 will have spikes that become sharper with a smaller p.

In high dimensions (the curse of dimensionality), much of the data will be on the surface of a hypercube. In that case, when 1≤p, any neighborhood of a particular volume, inside the hypercube, will be almost empty. However, for p<<1, a neighborhood with spikes can expand, without consuming the Euclidean volume, and hunt data scattered on the hypercube surface.

Definition 2

The population NCDF is NCDF_{∥⋅∥}_{ₚ}_{,X=x}. The random variable X∈ [symbol] ^{d} has a cumulative distribution function (CDF) F_{X} and includes a point x. The NCDF for X around x under ∥⋅∥ₚ is given by:

$${NCDF}_{{‖ \cdot ‖}_{p} , X = x} ( v ) = Pr [ {𝒩}_{{‖ \cdot ‖}_{p}} ( x , {V}_{{‖ \cdot ‖}_{p}}^{- 1} ( v ) ) ] \qquad Eq . 2 a$$

$$= {\int }_{𝒩} {dF}_{X} , \qquad Eq . 2 b$$

where V_{∥⋅∥}_{ₚ}(∈) is the volume of the neighborhood [symbol] _{∥⋅∥}_{ₚ}(x, ∈) and Equation 1b exists if F_{X} is differentiable (i.e., has a probability distribution function (PDF)).

The NCDF of a random variable X, around an observation x, is a function of the probability of a neighborhood under ∥⋅∥ₚ versus its volume v=V_{∥⋅∥}_{ₚ}(∈) (not versus its radius ∈=V_{∥⋅∥}_{ₚ}⁻¹(v))

The definition of the NCDF is not explicit to ∥⋅∥ₚ; it can be adopted for another general norm ∥⋅∥. However, another norm ∥⋅∥ must be defined before being able to find a relationship between the neighborhood radius an volume.

The NCDF is defined to be the probability versus the volume v of a neighborhood, rather than its radius ∈. This may provide a general definition that is applicable to other forms of norms that may imply several parameters to describe a neighborhood rather than a simple radius. Also, although there is a one-to-one mapping between the volume of the neighborhood and its radius, the probability of the neighborhood relates directly to its volume by the integration of the PDF (Equation 2b), if it exists.

The ball in Equation 1 is defined as closed (not open), which implies a right-continuous NCDF. This is in accordance with conventions for defining univariate CDFs.

Definition 3

The sample NCDF is [symbol] _{∥⋅∥}_{ₚ}_{,X=x}_{ᵢ}. A dataset {xᵢ|xᵢ˜i.i.d., i=1, . , n} is drawn from the random variable X. A nonparametric estimator of NCDF_{∥⋅∥}_{ₚ}_{,X=x}_{ᵢ} is the sample NCDF defined as:

$${{‖ \cdot ‖}_{p} , X = {x}_{i}}_{} ( v ) = \frac{1}{n} {\sum }_{j} {I}_{( {x}_{j} ∈ {𝒩}_{{‖ \cdot ‖}_{p}} ( {x}_{i} , {V}_{{‖ \cdot ‖}_{p}}^{- 1} ( v ) ) )} \qquad Eq . 3$$

The sample NCDF converges pointwise to the population NCDF.

The sample NCDF is a plot of β versus v, where β is the relative number of observations, with respect to the total number of observations n, in the neighborhood centered around the observation xᵢ and has a volume v. In one embodiment, β is the number of observations, within a neighborhood, divided by the total number of observations.

To draw [symbol] _{∥⋅∥}_{ₚ}_{,X=x}_{ᵢ}(v), computation of ∥xᵢ−xⱼ∥ₚ is performed for all j, the results are sorted, the volume at each distinct distance is calculated, the volumes are substituted into Equation (3), and the resulting points are plotted.

The resulting curve for an NCDF sample will be a staircase with horizontal segments and vertical jumps. A horizontal segment [v₁,v₂] represents a corresponding gap, in the feature space, between two empty neighborhoods, [symbol] ₁ and [symbol] ₂, of volumes v₁ and v₂, respectively. A vertical jump at v₂ has a value of Δn/n, where Δn is the number of observations at the boundary of [symbol] ₂.

Definition 4

(Population and sample family curves). A random variable X and a drawn dataset {xᵢ|xᵢ˜i.i.d. , i=1, , n} are considered. The population NCDF family of the random variable is the set of curves NCDF_{∥⋅∥}_{ₚ}_{,X}={NCDF_{∥⋅∥}_{ₚ}_{, X=x}|x∈support of X}; and the sample NCDF family of the data set is the set of curves [symbol] _{∥⋅∥}_{ₚ}_{,X}={ [symbol] _{∥⋅∥}_{ₚ}_{,X=x}_{ᵢ}, i=1, . . . , n}.

The complexity of generating [symbol] _{∥⋅∥}_{ₚ}_{,x} is n× the complexity of generating [symbol] _{∥⋅∥}_{ₚ}_{,X=x}_{ᵢ}, and the latter depends on the sorting algorithm

The sample NCDF family should be interpreted as a set of characteristics of the dataset because each curve is a characteristic of its generating observation.

At particular proximity level 0≤β≤1, a horizontal line (call it β-level), intersects with the n curves at n intercepts vᵢ; i=1, . . . , n; each value corresponds to an observation xi. These n intercepts are a sample of the population of volumes of n neighborhoods of probability. Therefore, if one of these intercepts has no close neighbors on this horizontal line, then this means that its corresponding observation is very different (anomalous) from the other observations. Said differently, other observations achieve the same β-level but at different volumes of neighborhoods.

An observation x, can look “anomalous” at some β₁-level but “normal” at some other β₂-level—if its NCDF curve has a point (vᵢ, β₂) that has close neighbors (vⱼ, β₂) for all j≠i on the horizontal line at ≠₂.

The characteristics of NCDF curves are a function of the selected norm. Therefore, in principle, what does not seem anomalous under a particular norm may look anomalous under others.

At Step 209, the NCDF curves may be presented. Presentation of the NCDF curves may include drawing, visualizing, displaying, etc., multiple graphs to a user device that correspond to the NCDF curves. The graphs may include an NCDF graph, a scatter plot matrix, a parallel coordinate plot, etc.

In one embodiment, the selection of NCDF curve may be selected in response to receiving a selection of the curve from a user device. For example, after the NCDF graph is displayed, the user may then select one of the NCDF curves from the NCDF graph using a human input device. Selecting the NCDF curve may trigger highlighting the selected NCDF curve on the NCDF graph and highlighting the curves of corresponding data on the other graphs (e.g., the scatter plot matrix and the parallel coordinate plot).

In one embodiment, presentation of the NCDF curves and the NCDF graph includes transmitting the NCDF graph, the NCDF curves, or both to a user device, which may display the NCDF curves and the NCDF graph. In one embodiment, the NCDF graph is displayed in response to a request received from a user device.

In one embodiment, an NCDF curve of the NCDF curves is selected that corresponds to the anomalous value. The selected NCDF curve may be highlighted and the NCDF curves may then be presented with the selected NCDF curve highlighted to visually identify the NCDF curve corresponding to the anomalous value. In one embodiment, the selection of the NCDF curve may be performed automatic based on a score of the NCDF curve.

In one embodiment, the NCDF curves are presented in an NCDF graph and with a scatter plot matrix and a parallel coordinate plot. The scatter plot matrix is a matrix of scatter plots generated from the input values. Each scatter plot of the matrix shows the relationship between two dimensions of the input values. The parallel coordinate plot displays each dimension of the input values with a separate axis. The input values are plotted as a series of lines that connect across the axes.

In one embodiment, the NCDF curves are presented in an interactive plot. The interactive plot may be a sponsor to user input to adjust scales of the plots displayed, which may include an NCDF graph, a scatter plot matrix, a parallel coordinate plot, etc.

At Step 210, the NCDF curves are processed to generate scores. The score for a corresponding input identifies whether the input value is an outlier by quantifying the outlierness of the input value with respect to the other input values. In one embodiment, a fraction of gap method is used. In one embodiment, a histogram method is used. In one embodiment, the “fraction of gaps” method calculates the distances between an intercept of the NCDF curves with the other intercepts of the NCDF curves and assigns the [nr]^{th} smallest distance, where 0<r<1 is a relaxing parameter, as the score. In one embodiment, the “histogram” method creates b bins for the intercepts of the NCDF curves with the i^{th} intercept being centered in one of the bins. Counts of the intercepts in each bin are calculated to identify the anomaly score. The score (the counts) are normalized to the range [0,1].

In one embodiment, generating the scores is nonparametric. For example, a probability distribution of the data of the input values is neither assumed nor taken as an input to the system to generate the scores. Additionally, the scores are generated without parameter tuning to control the accuracy of the algorithm For examples, the scores may be generated without using a fixed threshold.

In one embodiment, generating the scores is unsupervised. For example, the scores are generated with no prior training and without assuming data labeling for subsets of the data. Even single-class labeling is not assumed.

At Step 212, the scores are processed to identify an anomalous value, in the input data, that corresponds to a score, of the scores, meeting a criterion. For example, the criterion may be to identify the top n scores with the highest values as compared to the other scores generated by the system. The value of the nth score then identifies an adaptive threshold specific set of input data.

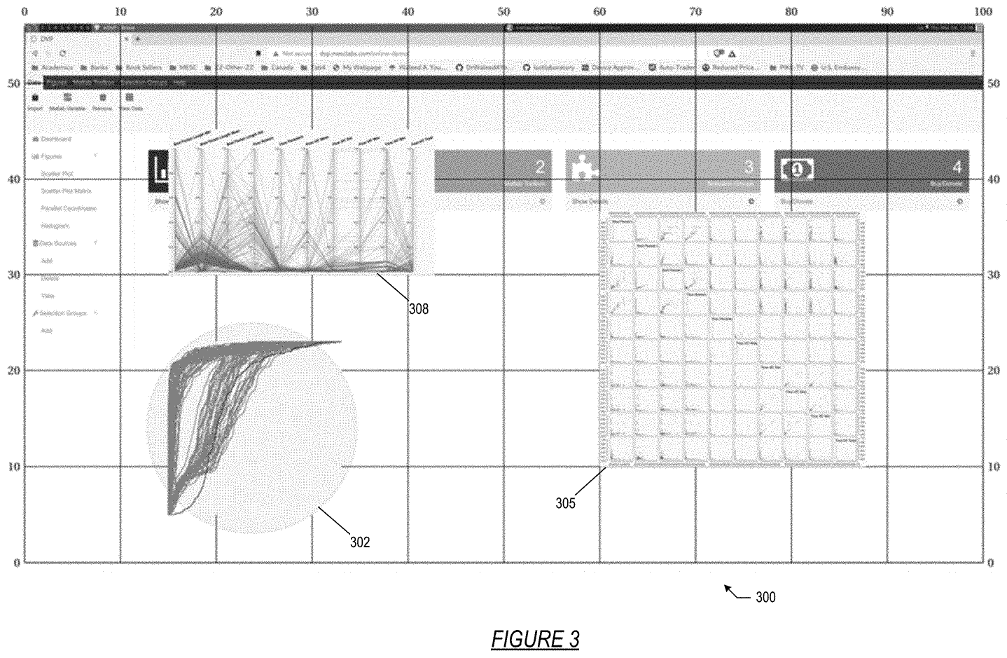

Turning to FIG. 3, the user interface (300) implements an unsupervised and nonparametric approach for visualizing outliers by invariant detection scoring. The user interface (300) may be displayed on a user device.

The user interface (300) includes user interface elements to display the analysis performed by the underlying system. The user interface elements include the graphs (302), (305), and (308).

The graph (302) is an NCDF graph that includes multiple NCDF curves. One NCDF curve may be displayed for each input value the input data identified by the user for the analysis. One of the NCDF curves is highlighted to identify that NDCF curve as corresponding an anomalous value of the input value of the input data selected by the user. In one embodiment, the highlighted NCDF curve is displayed with a red color in contrast to the remaining NCDF curves that are displayed with a dark grey color.

The graph (305) is a scatter plot matrix. The graph (305) includes multiple individual scatter plots between two of the dimensions do the input value of the input data. The graph (305) displays (100) plots of pairwise combinations of 10 dimensions of the input values of the input data.

The graph (308) is a parallel coordinate plot. The graph (308) plots the ten separate dimensions of the input values of the input data onto ten separate axes. A line is drawn for each input value that passes through each of the axes.

The graphs (302), (305), and (308) are displayed in response to user interaction. A user operates the system to identify input data from a database. The system then analyzes the input data and generates the graphs (302), (305), and (308). The graphs (302), (305), and (308) are transmitted to and displayed by the user device being operated by the user.

In one embodiment, the following pseudo code describes the algorithm used by the system to generate the graphs (302), (305), and (308) from the input data (referred to as X_{n×d}).

```
/*Initialize data and normalize features to [0;1]*/
Read X_{n×d} //the data matrix of input data with input values
for(j=1; j·d; j++) //normalizing each feature to [0,1]
  xⱼ = (xⱼ − xⱼₘᵢₙ)/(xⱼₘₐₓ − xⱼₘᵢₙ);
/*Construct NCDF space (a plot of n NCDF curves)*/
p = 2⁻⁴ //use a very small norm ∥·∥
for(i=1; i<n; i++){ //build matrix V_{n×n} of ∥·∥ distances
  for(j=i+1; j·n, j++){
    V(i,j) = ∥xᵢ − xⱼ∥ₚ;
    V(j,i) = V(i,j);
  }
  Sort V(i,:); //sort each row of V ascendingly
  V(i,:) = V(i,:)/V(i,n); //normalize by Vₘₐₓ
  PLT = Draw [symbol]    _{∥·∥p,X=x}_{ᵢ}; //a plot of n NCDF curves
}
/*Visualization step. */
Display PLT
Display scatter_plot_matrix // generated from X_{n×d}
Display parallel_coordinate_plot // generated from X_{n×d}
/*Detection step: anomaly scores for the NCDF curves*/
Beta = [0.01,0.02,...,1]; //dividing y-axis to l = 100 β-levels
r = 0.01; //initialize r for “fraction of gaps” method
b = 0.05n; //initialize bins for “histogram” method
for(i=1; i≤n; i++){
  for(j=1; j·1; i++){ //assign anomaly score at each β-level
    Inters = getIntercepts(Beta[j], [symbol]   ); // n×1 array
    switch (method){
      case “fraction of gaps”: //the fraction is r
        Gaps = |Inters − Inters[i]|;//n×1 array
        BetaScores[j] = getRthSmallest(r, Gaps); // n×1 array
      case “histogram”: //number of bins is b
        Counts = Hist(b, Inters); //b×1 array (intercepts)
        for(int b′, sum=0; b′=1; b′·b)
          //calculate relative probabilities in bins.
          sum += (Counts[b′]>Counts[i]) ? Counts[b′] : 0;
          BetaScores[j] = sum/n;
      }
    }
    Scores[i] = max(BetaScores); //n×1 array (anomaly scores)
}
```

The algorithm transforms the dataset from the feature space to the new NCDF space for both the visualization step, by rendering the curves to a plot, and the detection step, by assigning an anomalous score to each observation. The algorithm starts with normalizing each feature to [0; 1]; hence, the dataset will exist in the d-dimensional cube [0,1]^{d}. The n×n matrix of distances (V) between each pair of observations can be built under any selected L^{p} norm. An infinitesimal p=2⁻⁴ is used in the above. Because the volume of a particular neighborhood varies with the selected norm, normalization by the maximum volume under the selected norm is performed. The sample NCDF family is generated and visualized. Next, the analytical step starts by finding, for each NCDF, the β-level at which the NCDF has the largest horizontal gap that separates it from other NCDFs at the same level. Therefore, the sample NCDF family is cut at l levels, where each level cuts the family at n intercepts, each intercept corresponds to a volume, and each volume encloses the same number of observations βn. At each β-level, out of the l levels, the set of n intercepts are compiled into the array “Inters”, and for a given NCDF, an anomaly score is assigned based on the distribution of these intercepts. The outlier score for a given NCDF is then the maximum score across all the l levels. It is noted that l is not a complexity or tuning parameter of the algorithm Rather, the higher the l, the more slicing of the NCDF space and the higher level of certainty that the β-level that achieves the highest separation will be identified. Because at two different β-levels that are very close to each other the intercepts will be almost identical, there is not much of a gain in precision, except for the consumed computational power, from setting a very large value of 1.

In the algorithm above, for the i^{th} NCDF, we introduced two methods for assigning an anomaly score at a particular β-level (“Beta[j]”). Each method assigns the score based on the relative location of the i^{th} intercept (“Inters[i]”) with respect to the distribution of all intercepts (the array “Inters”).

Scoring method 1: “fraction of gaps”. The fraction of gaps method calculates the distances (“Gaps”) between “Inters[i]” and the other intercepts (“Inters”), and then assigns the [nr]^{th} smallest distance, where 0<r<1 is a relaxing parameter, as the anomaly score.

Scoring method 2: “histogram”. The histogram method creates b bins for the intercepts (“Inters”), with the i^{th} intercept (“Inters [i]”) being centered in one of the bins. The counts (“Counts”) of the intercepts in each bin is calculated, and then the anomaly score of the i^{th} NCDF is assigned as the count sum of all bins with a larger count than “Counts[i]”, which is the count of the bin of the i^{th} intercept. The anomaly score by either method is normalized to [0,1], which is invariant with the data distribution. (For scrutiny, the “normalized score” may be used to distinguish it from the “calibrated score”, where a score is both normalized and calibrated to a probability measure.)

The “fraction of gaps” methods is an intuitive and natural candidate. The anomalous curve appears in the NCDF in isolation with respect to other curves, which makes the separating distance from the other curves a natural candidate for the anomalous score. However, for the scores to be converging to a non-zero value, the distance should be measured between the curve of interest to the K=nr nearest curve, where 0<r<1.

The “histogram” method is related to a probability of probability and provides a different scoring mechanism than the “fraction of gaps” method. The “histogram” method estimates the probability of each intercept within its locality and then compares the probability of the intercept of interest to the other probabilities. A score is assigned based on this relative probability comparison.

Embodiments of the invention may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 4.1, the computing system (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), and numerous other elements and functionalities that implement the features and elements of the disclosure.

The computer processor(s) (402) may be an integrated circuit for processing instructions. For example, the computer processor(s) may be one or more cores or micro-cores of a processor. The computing system (400) may also include one or more input devices (410), such as a touchscreen, keyboard, mouse, microphone, touchpad, electronic pen, or any other type of input device.

The communication interface (412) may include an integrated circuit for connecting the computing system (400) to a network (not shown) (e.g., a local area network (LAN), a wide area network (WAN) such as the Internet, mobile network, or any other type of network) and/or to another device, such as another computing device.

Further, the computing system (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

The computing system (400) in FIG. 4.1 may be connected to or be a part of a network. For example, as shown in FIG. 4.2, the network (420) may include multiple nodes (e.g., node X (422), node Y (424)). Each node may correspond to a computing system, such as the computing system shown in FIG. 4.1, or a group of nodes combined may correspond to the computing system shown in FIG. 4.1. By way of an example, embodiments of the invention may be implemented on a node of a distributed system that is connected to other nodes. By way of another example, embodiments of the invention may be implemented on a distributed computing system having multiple nodes, where each portion of the invention may be located on a different node within the distributed computing system. Further, one or more elements of the aforementioned computing system (400) may be located at a remote location and connected to the other elements over a network.

Although not shown in FIG. 4.2, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (422), node Y (424)) in the network (420) may be configured to provide services for a client device (426). For example, the nodes may be part of a cloud computing system. The nodes may include functionality to receive requests from the client device (426) and transmit responses to the client device (426). The client device (426) may be a computing system, such as the computing system shown in FIG. 4.1. Further, the client device (426) may include and/or perform all or a portion of one or more embodiments of the invention.

The computing system or group of computing systems described in FIGS. 4.1 and 4.2 may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the invention. The processes may be part of the same or different application and may execute on the same or different computing system.

Rather than or in addition to sharing data between processes, the computing system performing one or more embodiments of the invention may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the invention, may extract one or more data items from the obtained data. For example, the extraction may be performed as follows by the computing system in FIG. 4.1. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 4.1, while performing one or more embodiments of the invention, may perform data comparison. Data comparison may be used to compare two or more data values (e.g., A, B). For example, one or more embodiments may determine whether A>B, A=B, A!=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the invention, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system in FIG. 4.1 may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, data containers (database, table, record, column, view, etc.), identifiers, conditions (comparison operators), functions (e.g., join, full join, count, average, etc.), sorts (e.g., ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 4.1 may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system of FIG. 4.1 and the nodes and/or client device in FIG. 4.2. Other functions may be performed using one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method comprising:
receiving a selection of input data comprising a plurality of input values;
processing the input data to generate a distance matrix;
processing the distance matrix to generate neighborhood cumulative distribution function (NCDF) curves;
processing the NCDF curves to generate scores; and
processing the scores to identify an anomalous value, in the input data, that corresponds to a score, of the scores, meeting a criterion.

2. The method of claim 1, further comprising:
selecting an NCDF curve, of the NCDF curves, that corresponds to the anomalous value; and
presenting the NCDF curves with the NCDF curve highlighted.

3. The method of claim 1, further comprising:
normalizing the input data to values between and including “0” and “1”.

4. The method of claim 1, further comprising:
generating the distance matrix under the p-norm with an infinitesimal value of p.

5. The method of claim 1, further comprising:
generating the distance matrix, wherein the distance matrix comprises a number of rows corresponding to the plurality of input values and a number of columns corresponding to the plurality of input values.

6. The method of claim 1, further comprising:
generating the NCDF curves using sample NCDFs.

7. The method of claim 1, wherein generating the scores is nonparametric.

8. The method of claim 1, wherein generating the scores is unsupervised.

9. The method of claim 1, further comprising:
presenting the NCDF curves in an NCDF graph and with a scatter plot matrix and a parallel coordinate plot.

10. The method of claim 1, further comprising:
generating the scores without using a fixed threshold.

11. The method of claim 1, further comprising:
presenting the NCDF curves in an interactive plot.

12. The method of claim 1, further comprising:
identifying the anomalous value using an adaptive threshold.

13. A system comprising:
a scoring controller configured to generate scores;
an application executing on one or more computers and configured for:
receiving a selection of input data comprising a plurality of input values;
processing the input data to generate a distance matrix;
processing the distance matrix to generate neighborhood cumulative distribution function (NCDF) curves;
processing the NCDF curves to generate scores; and
processing the scores to identify an anomalous value, in the input data, that corresponds to a score, of the scores, meeting a criterion.

14. The system of claim 13, wherein the application is further configured for:
selecting an NCDF curve, of the NCDF curves, that corresponds to the anomalous value; and
presenting the NCDF curves with the NCDF curve highlighted.

15. The system of claim 13, wherein the application is further configured for:
normalizing the input data to values between and including “0” and “1”.

16. The system of claim 13, wherein the application is further configured for:
generating the distance matrix under the p-norm with an infinitesimal value of p.

17. The system of claim 13, wherein the application is further configured for:
generating the distance matrix, wherein the distance matrix comprises a number of rows corresponding to the plurality of input values and a number of columns corresponding to the plurality of input values.

18. The system of claim 13, wherein the application is further configured for:
generating the NCDF curves using sample NCDFs.

19. A method comprising:
transmitting a request;
displaying a neighborhood cumulative distribution function (NCDF) graph in response to the request, wherein the NCDF graph is generated by:
receiving a selection of input data comprising a plurality of input values;
processing the input data to generate a distance matrix;
processing the distance matrix to generate neighborhood cumulative distribution function (NCDF) curves;
processing the NCDF curves to generate scores;
processing the scores to identify an anomalous value, in the input data, that corresponds to a score, of the scores, meeting a criterion;
selecting an NCDF curve, of the NCDF curves, that corresponds to the anomalous value; and
highlighting the NCDF curve.

20. The method of claim 19, further comprising:
selecting the NCDF curve in response to receiving a selection of the NCDF curve from a user device.
